(19) United States
(12) Patent Application Publication
(10) Pub. No.: US 2005/0060399 A1
(43) Pub. Date: Mar. 17, 2005

(54) Method and system for managing programs for web service system

(76) Inventors: Emi Murakami, Yokohama (JP); Isamu Adachi, Yokohama (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/893,925

(22) Filed: Jul. 20, 2004

(30) Foreign Application Priority Data
Aug. 12, 2003 (JP) 2003-207257

(51) Int. Cl. G06F 15/173

(52) U.S. Cl. 709/223; 709/201

(57) ABSTRACT

A service processing method includes the steps of transmitting identification information of undesired processing nodes from a first node to a management node so that such information can be registered as nodes that the first node does not want to request for processing, and sending an inquiry from a second node to the management node in accordance with a request for service sent from the first node so that, before the second node requests another node for processing, the second node can check if the other node is one of the nodes that the first node has registered as the undesired nodes, and then transmitting a request for processing from the second node to the other node or still another node that is not registered as a result of the inquiry. It becomes possible for a user to avoid undesired node at user's end.

### INCORPORATION BY REFERENCE

The present application claims priority from Japanese application JP2003-207257 filed on Aug. 12, 2003, the content of which is hereby incorporated by reference into this application.

### BACKGROUND OF THE INVENTION

The present invention relates to the techniques for adequately deciding to offer users services.

There is known a technique about the Web service composed of a plurality of secondary cooperative Web services offered by processing nodes dispersed as multiple servers. This technique is described in “Java Web Services” written by David A. Cbappell and others and published by O'Reilly & Associates, Inc., 2002, 3, page 6. This technique has the feature that, when a client sends a request for Web service, the client and each processing node cannot know the whole contents of the group of secondary Web services associated with this matter of Web service. The service providers to offer not only Web services but also general services have so far decided to offer services or not by using their own blacklists as, for example, in financial business.

### SUMMARY OF THE INVENTION

In such a service (including Web services) utilization mode, the mode has the structure that the service offer-side (system, apparatus or program) does not offer services to the persons or companies that are written in a blacklist. It is preferable for such service to also consider that the service user-side desires to avoid the services of the companies written in a blacklist, and thus, at the service user-side, it is possible to use the structure similar to that for the service offer-side.

An objective of the invention is that a request for service sent from the service user-side is decided to accept or not on the service processing-side before the service is launched.

The above objective can be achieved by the fact that a first node previously transmits information which is necessary for the request to be decided to accept or not to a management node so that this information can be registered in the management node, and a second node, before sending a request for processing the service to another node in response to a request for service from the first node, inquires the management node as to whether this service coincides with one of the nodes that the first node registered in the management node, then deciding to transmit the request for processing the service to the other node depending on the result of the inquiry.

In addition, the above objective can be achieved by the fact that a first node previously transmits identification information of processing nodes that the first node does not want to request for processing services to a management node, and a second node, before sending a request for processing a service to another node in response to a request for service from the first node, inquires the management node as to whether this service coincides with one of the nodes that the first node registered in the management node as those not wanted to request for processing the service, then deciding to transmit the request for processing the service to the other node that does not coincide any one of those undesired nodes depending on the result of the inquiry.

That is, this objective can be achieved by both providing a service for managing blacklists and using a blacklist added to the contents of the request for service.

This objective can also be achieved by the fact that a node receives a request for service that includes identification information of nodes not wanted to request for processing services, and the node, before sending a request for processing to another node, decides the other node that does not correspond to any one of the nodes not wanted to request according to the identification information included in the received service request.

### BRIEF DESCRIPTION OF THE DRAWINGS

FIG. 1 is a diagram showing an example of the construction of an on-line order system composed of a plurality of Web services according to one embodiment of the invention.

FIG. 2 is a diagram showing the details of the data about the registration of the blacklist transmitted from the service user 101 to the blacklist management service 103 and about the call to the interior-coordinating service-provider 106 in the system shown in FIG. 1.

FIG. 3 is a diagram showing the details of data of the inquiry about the blacklist transmitted from the interior-coordinating service-provider 106 to the blacklist management service 103 and about the result sent from the blacklist management service 103 in the system shown in FIG. 1.

FIG. 4 is a diagram showing the details of the data about the call transmitted from the interior-coordinating service-provider 106 to the antique-furniture order-service-provider 110 and about the answer from the provider 110 in the system shown in FIG. 1.

FIG. 5A is a diagram showing the contents of data transmitted as data 102 of request for blacklist registration from the service user 101 to the blacklist management service 103 in the system shown in FIG. 1.

FIG. 5B is a diagram showing the contents of data transmitted as data 105 of request for service to the interior-coordinating service-provider 106 in the system shown in FIG. 1.

FIG. 6 is a diagram showing the details of data transmitted back to the service user 101 from the interior-coordinating service-provider 106 as the result of checking if a Web service can be enjoyed without using undesired services in the system shown in FIG. 1.

FIG. 7A is a diagram showing the contents of data sent to the blacklist management service 103 as an inquiry as to whether each Web service is included in the blacklist in the system shown in FIG. 1.

FIG. 7B is a diagram showing the contents of data transmitted back from the blacklist management service 103 as the result of the inquiry as to whether each Web service is included in the blacklist in the system shown in FIG. 1.

FIG. 7C is a diagram showing the contents of data transmitted back to the service user 101 from the blacklist management service 103 as a result of the blacklist registration in the system shown in FIG. 1.

FIG. 8 is a diagram showing the contents of data transmitted from the interior-coordinating service-provider 106 to the antique-furniture order-service-provider 110 as a requested service in the system shown in FIG. 1.

FIG. 9A is a diagram showing an example of the connection in the system shown in FIG. 1.

FIG. 9B is a diagram showing the construction of the service user 101 shown in FIG. 1.

FIG. 9C is a diagram showing the construction of the blacklist management service 103 shown in FIG. 1 .

FIG. 10A is a diagram showing the construction of the interior-coordinating service-provider 106 shown in FIG. 1.

FIG. 10B is a diagram showing the construction of the antique-furniture service-provider 110 shown in FIG. 1.

FIG. 11A is a diagram showing the construction of the table dealer 114 shown in FIG. 1.

FIG. 11B is a diagram showing the construction of the furniture-maintenance agency B 120 shown in FIG. 1.

FIG. 12 is a diagram showing the flow of processes for transmitting an inquiry as to whether the service user 101 can enjoy a desired service without using the Web services of companies included in its own blacklist and for receiving the result of the inquiry.

FIG. 13A is a flowchart for the details of the process 404 for preparation for check of data of answer to inquiry about blacklist and service call shown in FIG. 12.

FIG. 13B is a flowchart for the details of the process 406 for data of service availability shown in FIG. 12.

FIG. 14A is a flowchart for the details of the process 401 for blacklist registration shown in FIG. 12.

FIG. 14B is a flowchart for the details of the process 402 for inquiry about blacklist shown in FIG. 12.

FIG. 15A is a flowchart for the details of the process 403 for search of blacklist shown in FIG. 12.

FIG. 15B is a flowchart for the details of the process 405 for preparation for data of answer to service availability shown in FIG. 12.

FIG. 16 is a flowchart for the details of the process 407 for check of data of service availability shown in FIG. 12.

FIG. 17 is a diagram showing another example of the on-line order system having a plurality of combined Web services but having no blacklist management service 103 as another embodiment of the invention.

FIG. 18A is a diagram showing the details of data about the call transmitted from the service user 1701 to the interior-coordinating service-provider 1703 and about the answer received from the provider 1703 in the system shown in FIG. 17.

FIG. 18B is a diagram showing the details of data about the call transmitted from the interior-coordinating service-provider 1703 to the antique-furniture order-service-provider 1705 in the system shown in FIG. 17.

FIG. 19 is a diagram showing the contents of data about the requested service sent from the interior-coordinating service-provider 1703 to the antique-furniture order-service-provider 1705 in the system shown in FIG. 17.

FIG. 20A is a diagram showing the connection in the system shown in FIG. 17.

FIG. 20B is a diagram showing the construction of the service user 1701 shown in FIG. 17.

FIG. 20C is a diagram showing the construction of the furniture-maintenance agency B 1710 shown in FIG. 17.

FIG. 21A is a diagram showing the construction of the interior-coordinating service-provider 1703 shown in FIG. 17.

FIG. 21B is a diagram showing the construction of the antique-furniture order-service-provider 1705 shown in FIG. 17.

FIG. 21C is a diagram showing the construction of the table dealer 1707 shown in FIG. 17.

FIG. 22 is a diagram showing the flow of processes for transmitting an inquiry as to whether the service user 1701 can enjoy a desired service without using the Web services of companies included in its own blacklist and for receiving the result of the request.

FIG. 23A is a flowchart for the details of the process 2201 for check of blacklist shown in FIG. 22.

FIG. 23B is a flowchart for the details of the process 2202 for preparation for service call shown in FIG. 22.

FIG. 24A is a flowchart for the details of the process 2203 for preparation for data of answer to service availability shown in FIG. 22.

FIG. 24B is a flowchart for the details of the process 2204 for data of service availability shown in FIG. 22.

### DESCRIPTION OF THE EMBODIMENTS

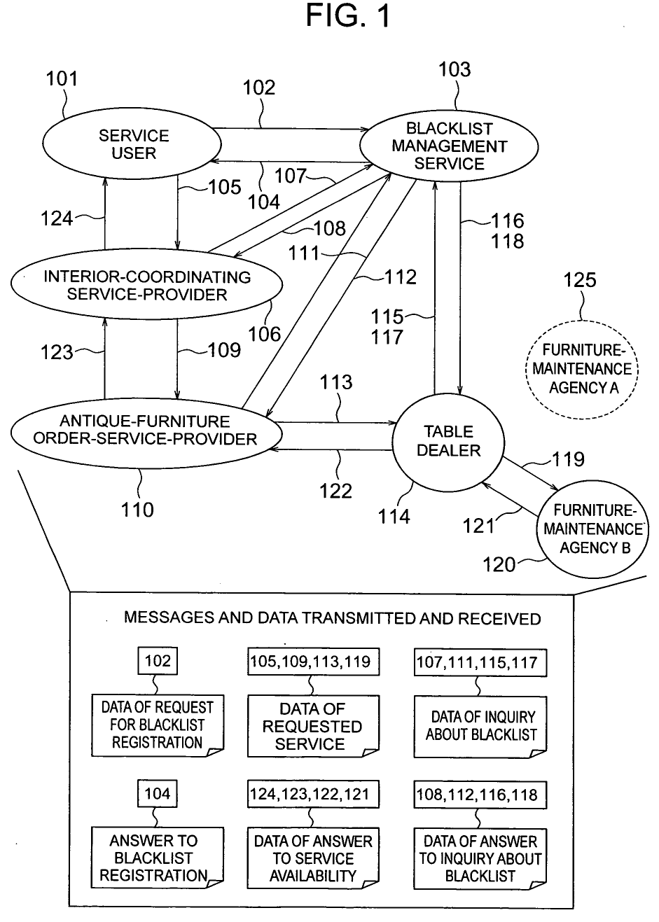

FIG. 1 is a diagram showing one example of the service processing by transmitting and receiving a request to process a plurality of Web services. Processing nodes (or simply nodes) 101, 103 and 106 for the service processing may be programs or objects that can process services, or apparatus, logic servers or logic computers that can make the service processing. Although an on-line order system built as an example will be described below, this invention is not limited to this example, but can be applied to the processing of general services.

A service user 101 who enjoys services as shown in FIG. 1 transmits a previously produced blacklist to a blacklist managing service (also called the management service or management node) 103, and orders an interior-coordinating service-provider 106 to do interior coordinating.

The management service 103 shown in FIG. 1 is a Web service that manages information of blacklists previously produced by the service user (system, apparatus or program) 101, and that the service user 101 can place trust in. The service user 101 may produce data of request 102 for registering the blacklist as shown in FIG. 1. The data 102 is transmitted from the service user 101 to the management service 103.

Data 104 of answer to the request for the registration as shown in FIG. 1 is transmitted from the management service 103 to the service user 101. Data 105 of request for service as shown in FIG. 1 is transmitted from the service user 101 to the interior-coordinating service-provider (system, apparatus or program) 106 shown in FIG. 1.

The service provider (system, apparatus or program) 106 shown in FIG. 1 is ordered by the service user 101 to search for a Web service that is to be requested next by using UDDI (Universal Descriptions, Discovery and Integrations). Then, it sends inquiries to the management service 103 about information of if an antique-furniture order-service-provider 110 as the search results is included in the blacklist of the service user 101. If this provider 110 is not included in the blacklist, it calls the provider 110.

Data 107 of inquiry as to the blacklist shown in FIG. 1 is transmitted from the interior-coordinating service-provider 106 to the management service 103. Data 108 of answer to the inquiry about blacklist as shown in FIG. 1 is transmitted from the management service 103 to the provider 106. Data 109 of a request for service as shown in FIG. 1 is transmitted from the provider 106 to the provider (system, apparatus or program) 110.

The provider 110 shown in FIG. 1 accepts the order from the provider 106, and searches for a Web service that is to be requested next by using UDDI. Then, it sends an inquiry to the management service 103 about information of if a table dealer 114 as the search results is included in the blacklist of the service user 101. If this dealer is not in the blacklist, the provider 110 calls the table dealer 114. Data 111 of an inquiry about the blacklist as shown in FIG. 1 is transmitted from the provider 110 to the management service 103. Data 112 of answer to the inquiry about blacklist as shown in FIG. 1 is transmitted from the management service 103 to the provider 110.

Data 113 of request for service as shown in FIG. 1 is transmitted from the provider 110 to the table dealer 114 in the same way that the data 109 is transmitted. The table dealer 114 shown in FIG. 1 accepts the order from the provider 110, and searches for a Web service that is to be requested next by using UDDI. Then, it sends an inquiry to the management service 103 about information of if a furniture-maintenance agency A 125 as the search results is included in the blacklist of the service user 101. If this agency is included in the blacklist, the table dealer 114 again searches for another Web service that is to be requested next by using UDDI. Then, it sends an inquiry to the management service 103 about information of if another furniture-maintenance agency B 120 as the search results is included in the blacklist of the service user 101. If this agency is not included in the blacklist, the table dealer 114 calls the agency B 120.

Data 115 and 117 for inquiry about the blacklist as shown in FIG. 1 is transmitted from the table dealer (system, apparatus or program) 114 to the management service 103 as is the data 111 for inquiry about the blacklist. In this embodiment, in response to the data 115, the furniture-maintenance agency A in the blacklist 125 has been picked up, and the inquiry data is issued again as 117. Data 116 and 118 of answer to the inquiry about blacklist as shown in FIG. 1 is transmitted from the management service 103 to the table dealer 114 as is the data 112 to answer for the inquiry about blacklist. Since the answer data 116 shows the furniture-maintenance agency A 125 in the blacklist, the answer data is again issued as the data 117.

The furniture-maintenance agency A (system, apparatus or program) 125 shown in FIG. 1 is a company that is written in the blacklist of the service user 101. The furniture-maintenance agency B 120 shown in FIG. 1 is a Web service that accepts the order from the table dealer 114 (system, apparatus or program), and that is located at the end of the multistage-type cooperative Web services that work with each other so as to secure the order from the service user 101.

Data 119 of request for service as shown in FIG. 1 is transmitted from the table dealer 114 to the furniture-maintenance agency B 120 as is the data 113 of request for service. Data 121 of answer to the service availability as shown in FIG. 1 is transmitted from the furniture-maintenance agency B 120 to the table dealer 114. Data 122 of answer to the service availability as shown in FIG. 1 is transmitted from the table dealer 114 to the provider 110 as is the data 121. Data 123 of answer to the service availability as shown in FIG. 1 is transmitted from the provider 110 to the provider 106 as is the data 122. Data 124 of answer to the service availability as shown in FIG. 1 is transmitted from the provider 106 to the service user 101 as is the data 123.

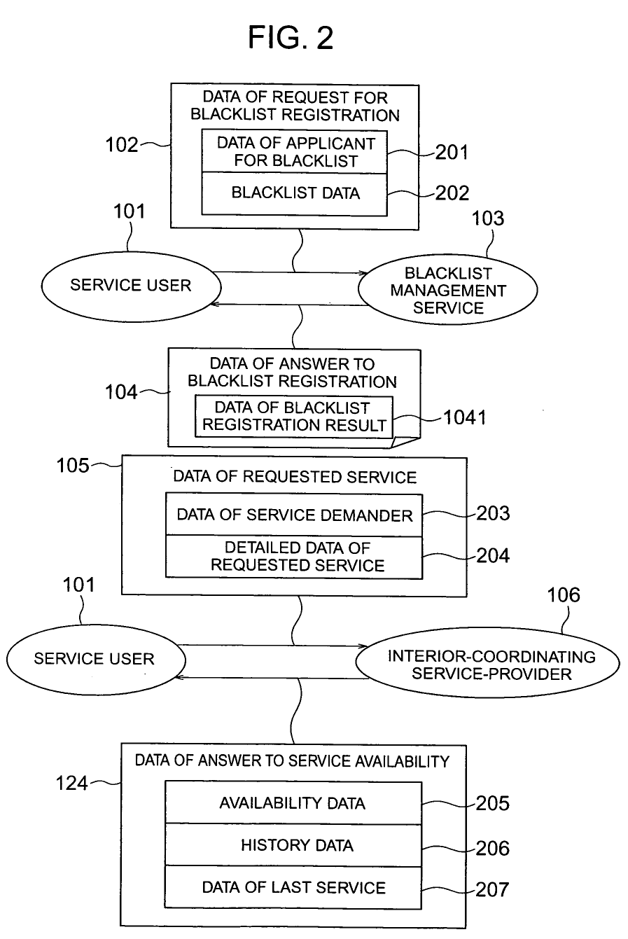

FIG. 2 is a diagram showing the details of the data of the request for blacklist registration transmitted from the service user 101 to the management service 103 up to the call from the service user to the service provider 106 in the system shown in FIG. 1.

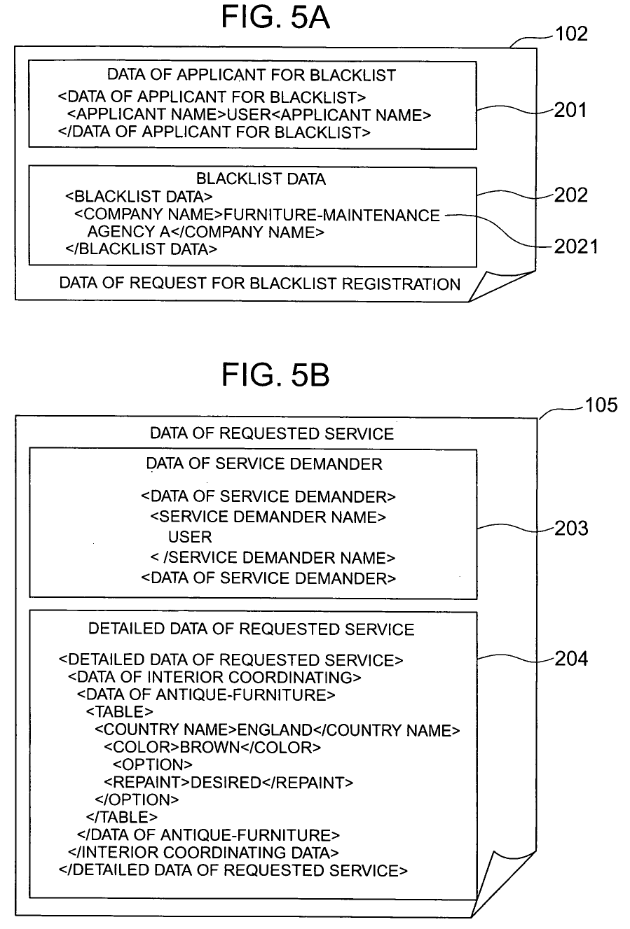

The data of request 102 for registering the blacklist as shown in FIG. 2 is transmitted from the service user 101 to the management service 103. This data 102 is composed of applicant data 201 and blacklist data 202 of which the details are shown in FIG. 5A.

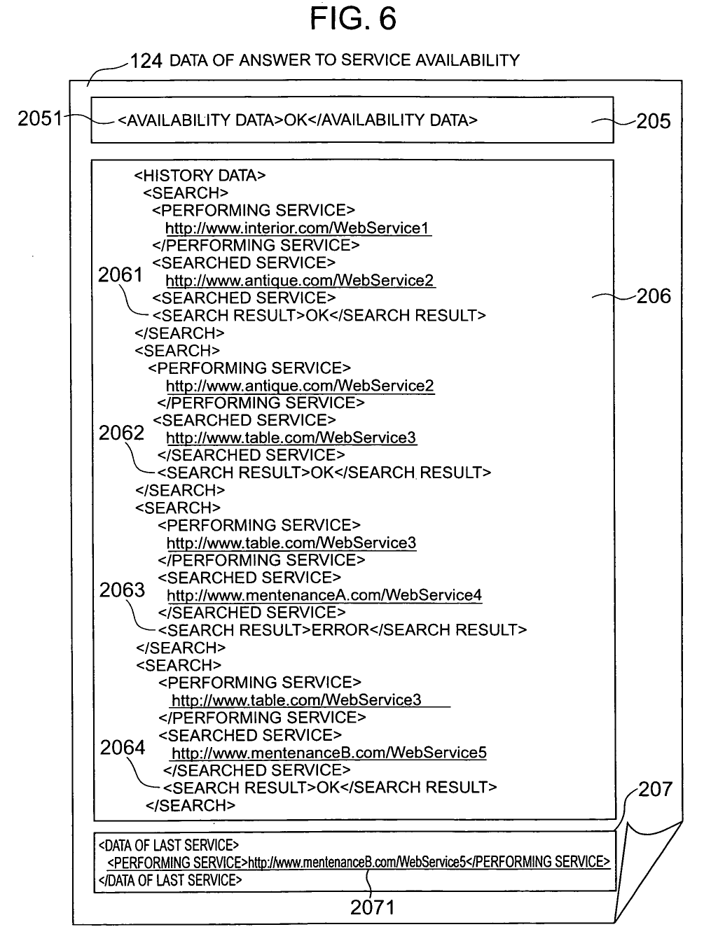

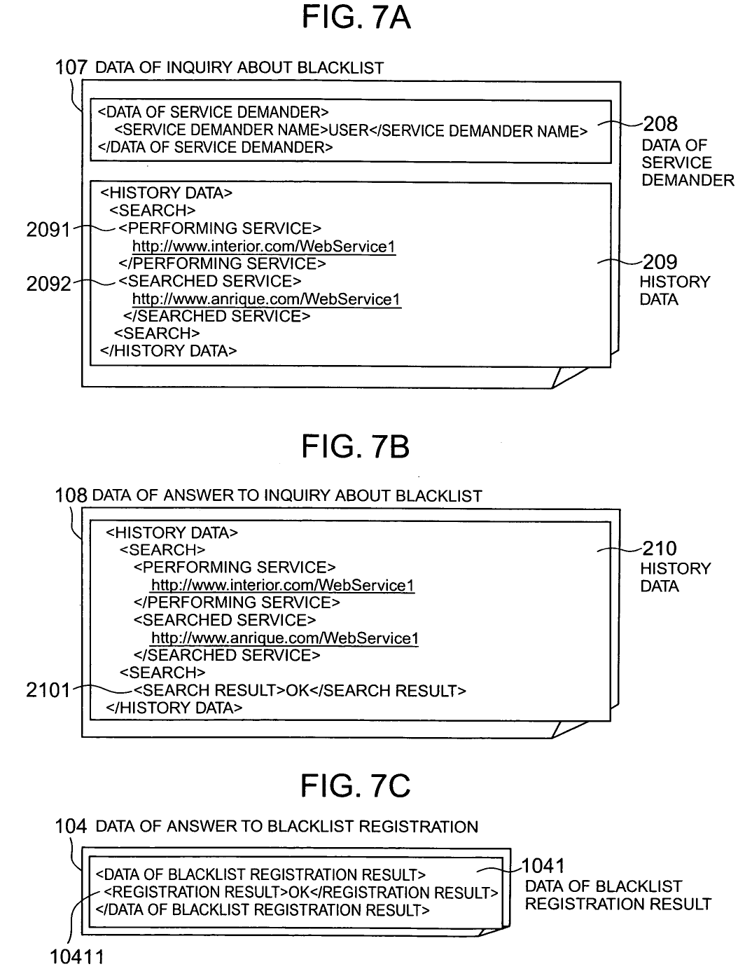

In this embodiment, data 201 and 202 are both expressed in XML format. The data 104 of answer to the blacklist registration shown in FIG. 2 is composed of data 1041 of the results of the blacklist registration that is shown in detail in FIG. 7C. The data 105 of request for service shown in FIG. 2 is composed of demander data 203 and detailed service data 204 of which the details are shown in FIG. 5B. The data 124 of answer to the service availability shown in FIG. 2 is composed of data 205 of service availability, history data 206 and data 207 of last service of which the details are shown in FIG. 6.

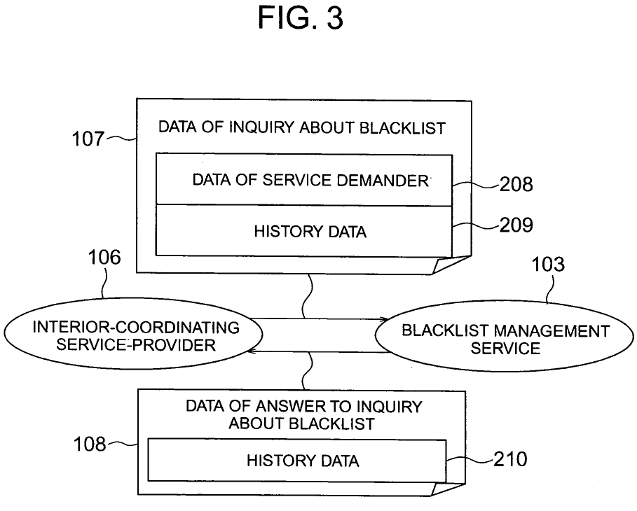

FIG. 3 is a diagram showing the details of the data of the inquiry about blacklist and the results transmitted and received between the provider 106 and the management service 103 shown in FIG. 1. The inquiry data 107 shown in FIG. 3 is composed of demander data 208 and history data 209 of which the details are shown in FIG. 7A. The answer data 108 shown in FIG. 3 is composed of history data 210 of which the details are shown in FIG. 7B.

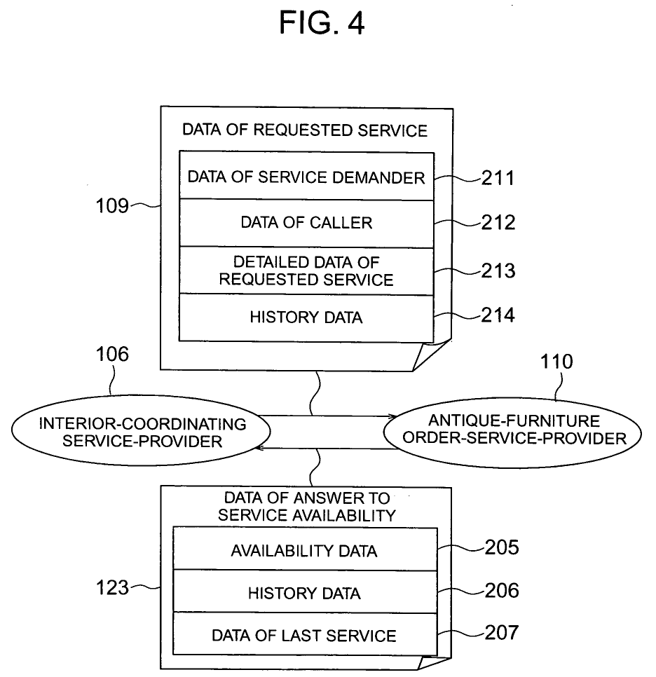

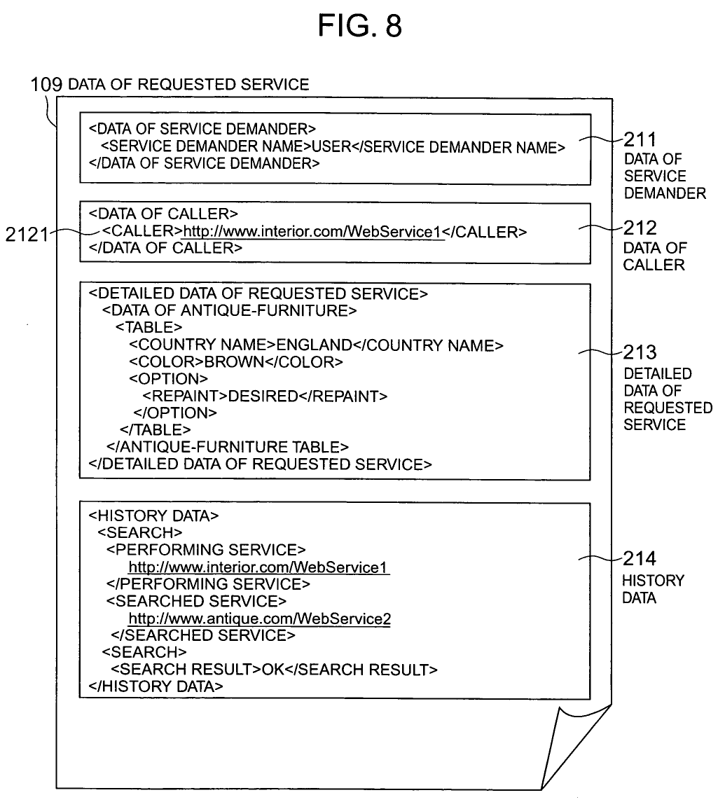

FIG. 4 is a diagram showing the details of the data of requested service and data of answer to service availability transmitted between the interior-coordinating service-provider (system, apparatus or program) 106 and the antique-furniture order-service-provider 110 shown in FIG. 1. The requested-service data 109 shown in FIG. 4 is composed of demander data 211, caller data 212, detailed data 213 of requested service and history data 214 of which the details are shown in FIG. 8.

The Data 123 of answer to the service availability shown in FIG. 4 has substantially the same structure as the data 124 shown in FIG. 2, but it does not include any information on availibility, discribed later, such as “OK” or “NG”.

FIGS. 5A and 5B show two kinds of data of which one has the contents of data 102 of request for registration transmitted from the service user 101 to the management service 103 and of which the other one has the contents of data 105 of requested service transmitted from the service user 101 to the interior-coordinating ervice-provider 106. The former is composed of applicant data 201 that indicates the contents of applicant information and blacklist data 202 that indicates the contents of the blacklist information. The latter is composed of demander data 203 that indicates the contents of the service user and detailed service data 204 that indicates the contents of the service desired by the service user.

In this embodiment, applicant name is specified for the data indicative of the contents of the applicant information as shown in FIG. 5A. The blacklist data 202 in FIG. 5A is the data of the blacklist previously produced by the service user 101. In this embodiment, company name 2021 is specified for the furniture-maintenance agency A. The demander data 203 in FIG. 5B is the data indicative of the service user information. In this embodiment, the service user is specified for the data 203. The detailed service data 204 in FIG. 5B is the data of the service information desired by the service user. This embodiment specifies items of interior coordination, particularly including an antique table made in England and with brown color and option of repaint.

FIG. 6 is a diagram showing the details of the answer data 124 to the request transmitted from the interior-coordinating service-provider 106 to the service user 101. The data 124 of answer shown in FIG. 6 is the result of checking if the request for Web service can be accepted as the service user demands. It is composed of availability data 205 indicative of the result of the checking, history data 206 used to produce the data 205, and data 207 of last service.

The data 205 of availability shown in FIG. 6 is the result of checking if the service user can enjoy a desired Web service without using any undesired Web service. The checked data 2051 of availability takes either OK or NG. In this embodiment, OK is taken.

The history data 206 shown in FIG. 6 is the data of history about the inquiries of Web service blacklist made to the management service 103 in association with the results of the inquiries as to each called-out Web service of the multistage-type cooperative Web services. The blacklist management service 103 checks if each Web service is included in the blacklist of the service user 101 and writes the result in the data 2061, 2062, 2063 and 2064 as either OK or ERROR. The result OK means that the Web service is not included in the blacklist, and ERROR means that it is included in the blacklist. The last-service data 207 shown in FIG. 6 is the data of Web service information located at the end of the multistage-type Web services. In this embodiment, the last service is specified as at the performed service 2071 that indicates the furniture-maintenance agency B of http://www.mentenanceB.com/Webservice5.

The data 107 of inquiry as to the blacklist and the data 108 of answer to the inquiry about blacklist shown in FIGS. 7A and 7B are the details of the data transmitted between the service provider 106 and the management service 103 shown in FIG. 1 as the inquiries as to whether each Web service is not included in the blacklist and as the results fed back from the management service 103.

The inquiry data 107 shown in FIG. 7A is composed of demander data 208 that indicates whose blacklist corresponds to the inquiry to the management service 103, and history data 209. The demander data 208 shown in FIG. 7A is the information for specifying the corresponding one of the blacklists managed by the management service 103. In this embodiment, service demander data 208 is used to specify the corresponding service user 101. The history data 209 shown in FIG. 7A is the data of history that indicates the inquiry that the provider 106 sent to the management service 103 as to whether the blacklist of the service user 101 includes the antique-furniture order-service-provider 110 as a Web service desired to call out next. In this embodiment, the interior-coordinating service-provider 106 is specified as inquiry-sending service 2091 located at http://www.interior/com/WebService1, and the antique coordinating service provider (system, apparatus or program) 110 as searched service 2092 located at http://www.antique.com/WebService2.

The data 108 of answer to the inquiry about blacklist shown in FIG. 7B is composed of history data 210. The history data 210 shown in FIG. 7B is the data resulting from searching the blacklist of the service user, of the managed blacklists, specified by the demander data 208 on the basis of the inquiry data 107 received by the management service 103 and writing the result in search result 2101. This embodiment uses OK indicating that the result is not included in the blacklist.

The data 104 of answer to the request for the registration shown in FIG. 7C is the data indicating if the registration request data 102 as the blacklist information received by the management service 103 has been correctly registered. This embodiment uses OK that is written in registration result 10411 to indicate that the blacklist has been correctly registered.

FIG. 8 is a diagram showing the details of the data of requested service that is transmitted from the provider 106 to the provider 110 in the system shown in FIG. 1. The requested-service data 109 shown in FIG. 8 is composed of demander data 211, caller data 212, detailed data 213 of service and history data 214.

The demander data 211 shown in FIG. 8 is the data for use in the data 107 of inquiry about blacklist that is produced when a Web service that will be probably called sends an inquiry to the management service. The caller data 212 shown in FIG. 8 indicates the information about the source of calling a Web service. The called Web service can return the result to the caller Web service by using this information. In this embodiment, caller 2121 is used to specify the provider 106 located at http://www.interior.com/WebService1. The detailed service data 213 shown in FIG. 8 is the data indicating the information about the desired service. In this embodiment, this information for antique furniture is specified as a table made in England with brown color and option of repaint.

The history data 214 shown in FIG. 8 is the answer data 108 themselves.

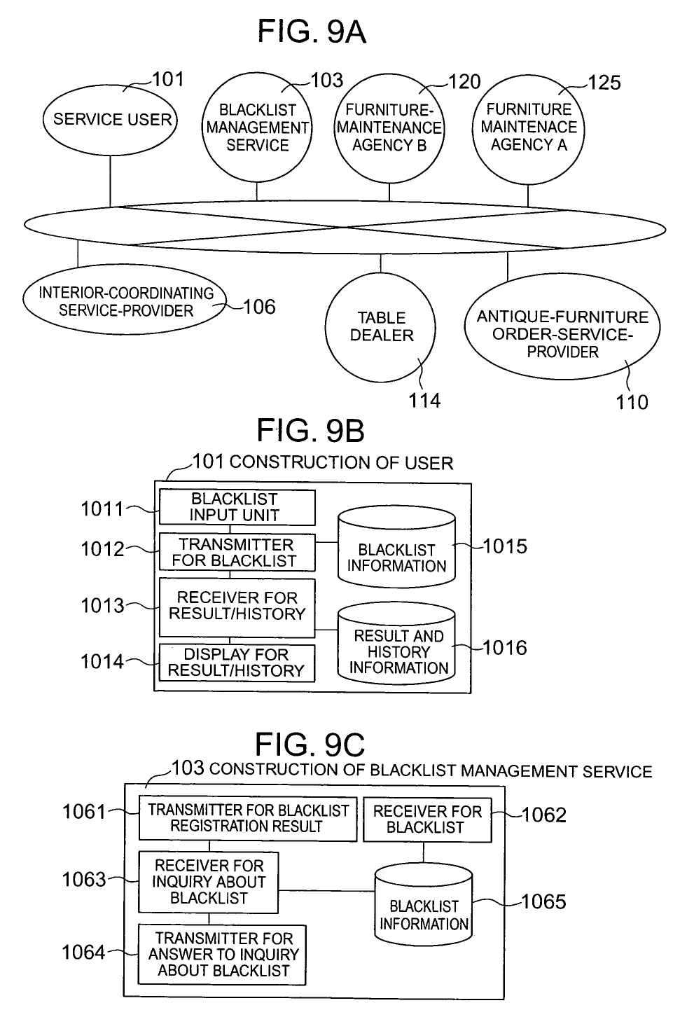

FIG. 9A is a diagram showing the interconnection of service user 101, management service 103 and so on shown in FIG. 1. The service user 101 shown in FIG. 9B is constructed to have a blacklist input unit 1011 for entering the blacklist, a blacklist information storage 1015 for storing the entered blacklist information, a blacklist transmitter 1012 for transmitting the blacklist, a result/history receiver 1013 for receiving the result and history, a result/history storage 1016 for storing the received result and history and a result/history display 1014 for displaying the received result and history.

The management service 103 shown in FIG. 9C is constructed to have a blacklist receiver 1062 for receiving the registration-request data 102, a blacklist-information storage 1065 for storing the received data 102, a registration-result transmitter 1061 for transmitting the result of if the blacklist has been correctly registered, an inquiry-data receiver 1063 for receiving the data of inquiry about blacklist from each Web service, and an answer-data transmitter 1064 for transmitting the result.

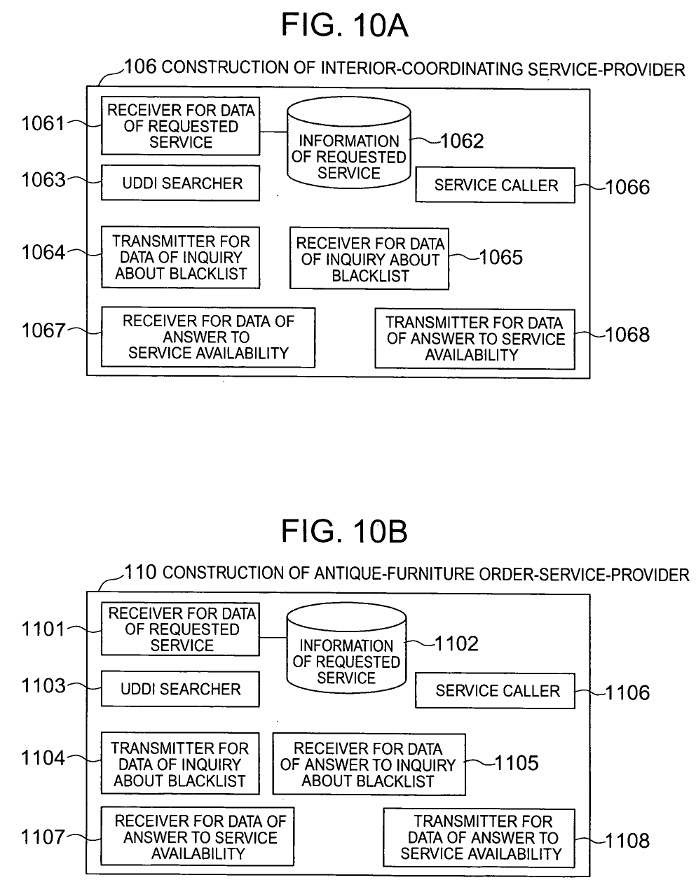

FIG. 10A is a diagram showing the construction of interior-coordinating service-provider 106 shown in FIG. 1. FIG. 10B is a diagram showing the construction of antique-furniture service-provider 110 shown in FIG. 1. The provider 106 shown in FIG. 10A is constructed to have a service-data receiver 1061 for receiving requested-service data 105, a service-information storage 1062 for storing the received data, a UDDI searcher 1063 for searching for a Web service to be called out next, an inquiry-data transmitter 1064 for transmitting an inquiry as to whether the Web service to be called out next as a result of the search is included in the blacklist, an answer receiver 1065 for receiving the result, a service caller 1066 for calling the next Web service, an answer-data receiver 1067 for receiving data 123 of answer to service availability, and an answer-data transmitter 1068 for transmitting data 124 of answer to service availability.

The antique-furniture order-service-provider 110 shown in FIG. 10B is constructed to have a service-data transmitter 1101 for receiving requested-service data 109, a service-information storage 1102 for storing the received service data, a UDDI searcher 1103 for searching for a Web service to be called next, an inquiry-data transmitter 1104 for transmitting an inquiry as to whether the Web service desired to call next as a result of the search is included in the blacklist, an answer-data receiver 1105 for receiving the result, a service caller 1106 for calling the next Web service, an availability-answer receiver 1107 for receiving data 122 of answer to service availability, and an availability-answer transmitter 1108 for transmitting data 123 of answer to service availability.

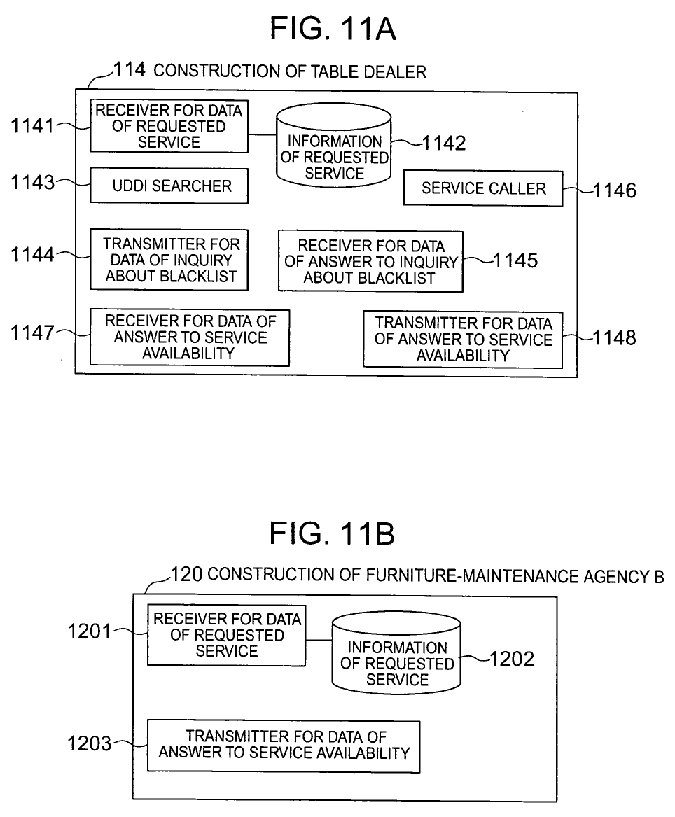

FIG. 11A is a diagram showing the construction of the table dealer 114 shown in FIG. 1, and FIG. 11B is a diagram showing the construction of the furniture-maintenance agency B 120. The table dealer 114 shown in FIG. 11A is constructed to have a requested-service receiver 1141 for receiving data 113 of requested service, a requested-service information storage 1142 for storing the received requested-service data, an UDDI searcher 1143 for searching for a Web service to be called next, an inquire-data transmitter 1144 for inquiring if the Web service desired to call next is included in the blacklist, an answer-data receiver 1145 for receiving the result, a service caller 1145 for calling the next Web service, an availability-answer receiver 1147 for receiving data of answer to service availability 121, and an availability-answer transmitter 1148 for transmitting data of answer to service availability 122.

The furniture-maintenance agency B 120 (system, apparatus or program) shown in FIG. 11B is constructed to have a requested-service data receiver 1201 for receiving requested-service data 119, a requested-service information storage 1202 for storing the received requested-service data, and an answer data transmitter 1203 for transmitting data of answer to service availability 121.

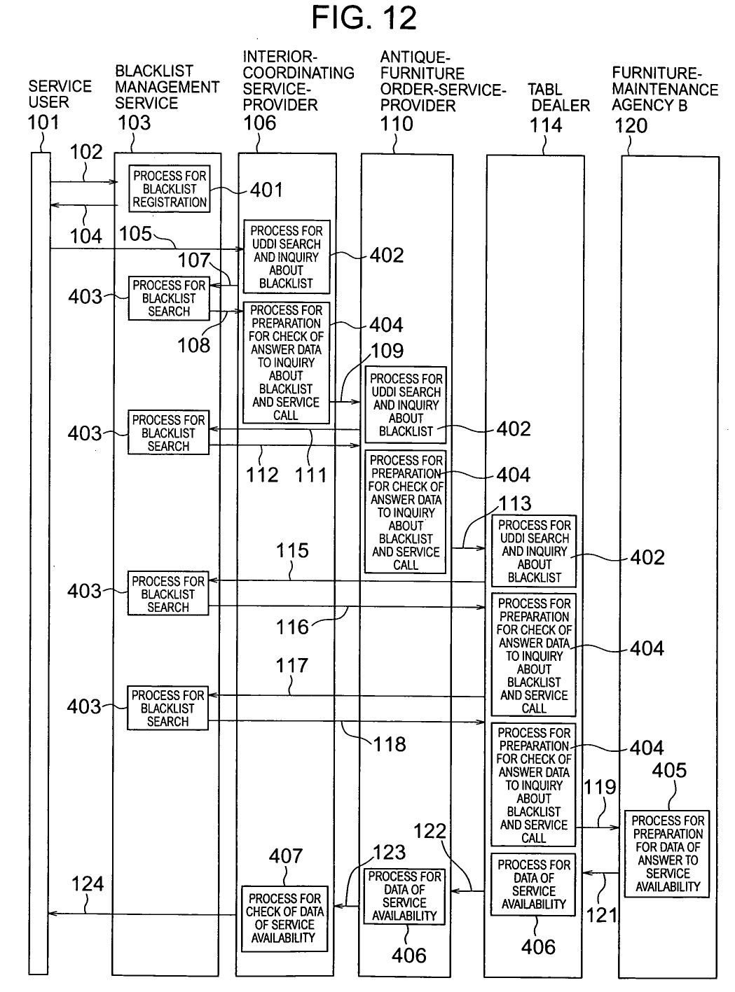

FIG. 12 is a diagram showing the flow of the processes for the service user 101 to inquire as to whether the service user can enjoy a desired service without using the Web services of the companies included in its own blacklist and then to receive the result. The service user 101 transmits the data 102 of request for blacklist registration to the blacklist management service 103. The management service 103 makes a process 401 for blacklist registration (step 401) on the basis of the received data 102 of request for blacklist registration. Then, the management service 103 sends data of answer to blacklist registration 104 back to the service user 101.

The service user 101 confirms from the result of answer data 104 that the data 102 of request for blacklist registration has been correctly registered, and transmits requested-service data 105 to the interior-coordinating service-provider 106. The provider 106 makes a UDDI search and process 402 for inquiry about blacklist (step 402) on the basis of the received service data 105. Then, the provider 106 transmits data 107 of inquiry about blacklist to the management service 103.

The management service 103 makes a process 403 for search of blacklist (step 403) on the basis of the received inquiry data 107, and sends answer data 108 back to the provider 106.

The provider 106 makes a process 404 for preparation for check of data of answer and call of service (step 404) on the basis of the received answer data 108, and sends service data 109 to the antique-furniture order-service-provider 110.

The provider 110 also executes the same step 402 as does the provider 106, and the management service 103 executes the step 403. The provider 110 executes the step 404 according to the result and sends the service data 113 to the table dealer 114.

The table dealer 114 executes the same steps as those performed by the providers 106 and 110, but since the corresponding service is included in the blacklist as a result of the first round of step 403, the table dealer 114 again transmits the inquiry data 117 to the management service 103.

As a result of the second round of inquiry, the corresponding service is not included in the blacklist, and thus the table dealer 114 transmits the service data 119 to the agency B 120.

The agency (system, apparatus or program) B 120 makes a process 405 for preparation for data of answer to service availability (step 405) on the basis of the received service data 119, and transmits answer data 121 to the table dealer 114.

The table dealer 114 makes a process 406 for data of service availability on the basis of the received answer data 121, and transmits the answer data 122 to the provider 110.

The provider 110 makes a process 405 for preparation for data of answer to service availability (step 405) on the basis of the received answer data 122, and transmits the answer data 123 to the provider 106.

The provider 106 makes a process 407 for check of data of service availability on the basis of the answer data 123, and transmits the answer data 124 to the service user 101.

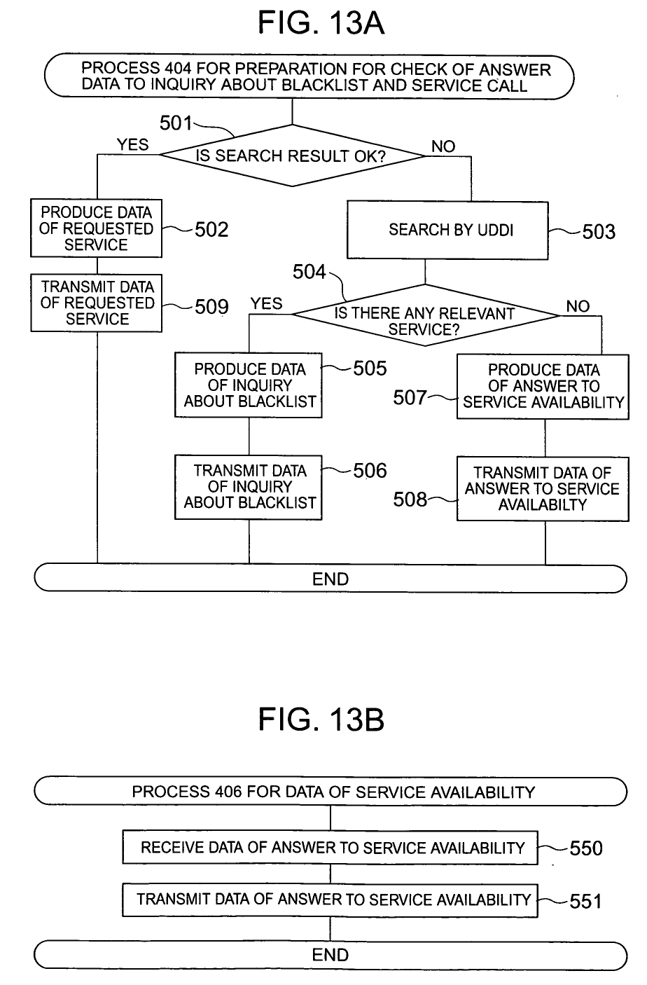

FIGS. 13A and 13B are flowcharts for the details of the blacklist-inquiry process 404 for preparation for check of data of answer and call of service and process 406 for data of service availability shown in FIG. 12, respectively.

In the process 404 shown in FIG. 13A, step 501 is first executed of whether the result of searching as to the received answer data is OK. If it is OK, requested-service data is produced and transmitted (steps 502, 509). If the result is not OK, UDDI searching is made in the step 503 in order to search for a Web service to be called next. Then, in step 504 judgment is made of whether the corresponding service is included in the blacklist. If it is not included, data of answer to service availability is produced and transmitted to the caller.

If it is included, blacklist-inquiry data is produced and transmitted (steps 505, 506).

In the process 406 shown in FIG. 13B, data of answer to service availability is produced and transmitted to the caller (steps 550, 551).

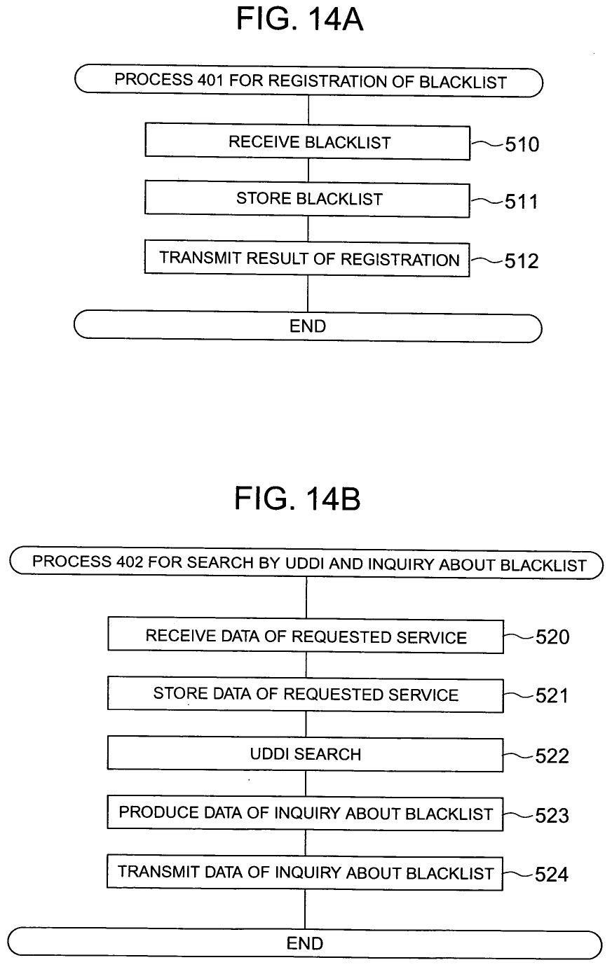

FIGS. 14A and 14B are flowcharts for the details of the process 401 for blacklist registration and process 402 for UDDI search and inquiry about blacklist shown in FIG. 12, respectively.

In the process 401 shown in FIG. 14A, the blacklist-registration data 102 is received and stored, and then the result of the registration is transmitted as data of answer to blacklist registration 104 (steps 510, 511, 512). In the process 402 shown in FIG. 14B, first the requested-service data is received (step 520), the received data is stored (step 521), and then a Web service to be called next is searched for by UDDI (step 522). Blacklist-inquiry data is produced (step 523), and transmitted (step 524).

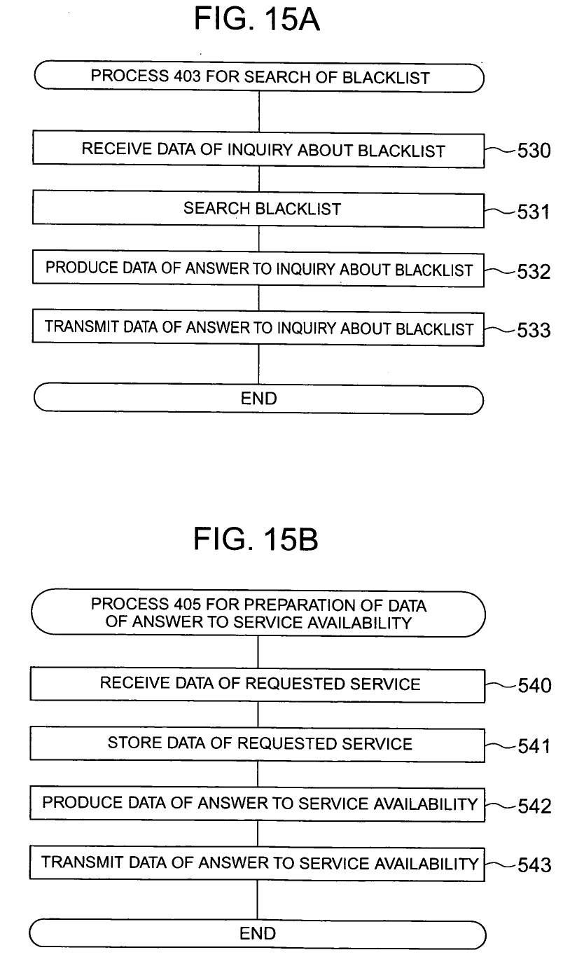

FIGS. 15A and 15B are flowcharts for the details of the process 403 for search of blacklist and process 405 for preparation for data of answer to service availability shown in FIG. 12, respectively.

In the process 403 shown in FIG. 15A, blacklist-inquiry data is received (step 530). The blacklist information that the management service 103 itself manages is searched to judge if the corresponding service is included in the blacklist (step 531). Data of answer to blacklist inquiry is produced according to the search result. (step 532), and transmitted (step 533). In the process 405 shown in FIG. 15B, the requested-service data is received (step 540) and stored (step 541), and data of answer to service availability is produced (step 542) and transmitted (step 543).

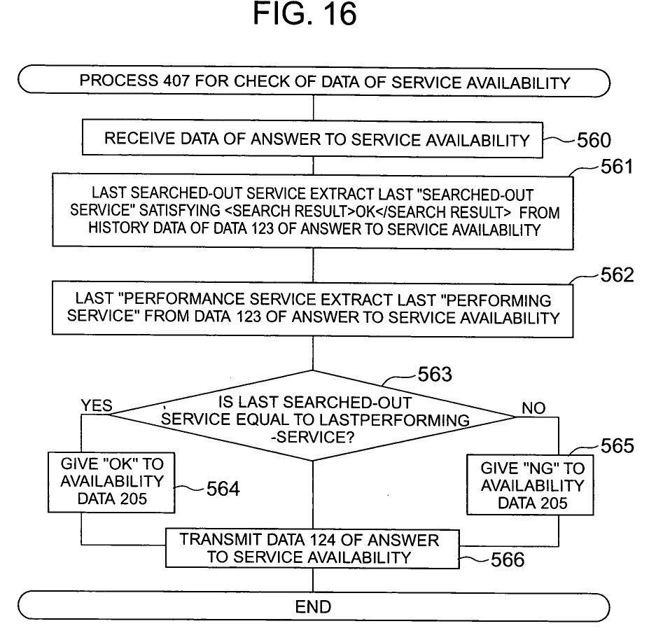

FIG. 16 is a flowchart for the details of the process 407 for check of data of service availability shown in FIG. 12. In the process 407 shown in FIG. 16, the data of answer to service availability 123 is received (step 560), and information is extracted about the service to be finally searched and about the finally performing service (steps 561, 562) on the basis of the received data 123. Judgment is made of whether the pieces of information extracted in the steps 561, 562 coincide with each other (step 563). If they coincide with each other, OK is set in the availability data (step 564). If they do not coincide, NG is set in the data and transmitted as data 124 (step 566).

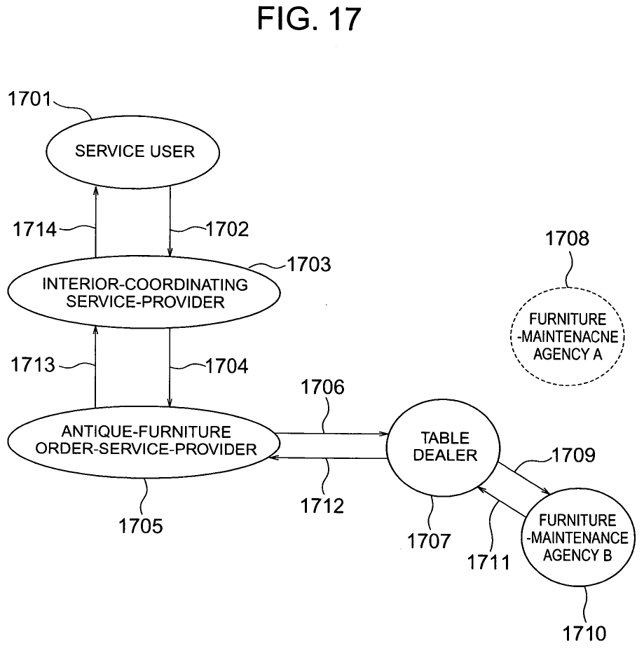

Another embodiment of the invention will be described with reference to FIG. 17.

FIG. 17 is a diagram showing the case in which the management service 103 is not provided in the example shown in FIG. 1. This embodiment is thus the same as the previous embodiment except that no data is transmitted or received by the blacklist management service 103. In this embodiment, a service user itself has information on the undesired nodes, and data is transmitted to the providers with the information.

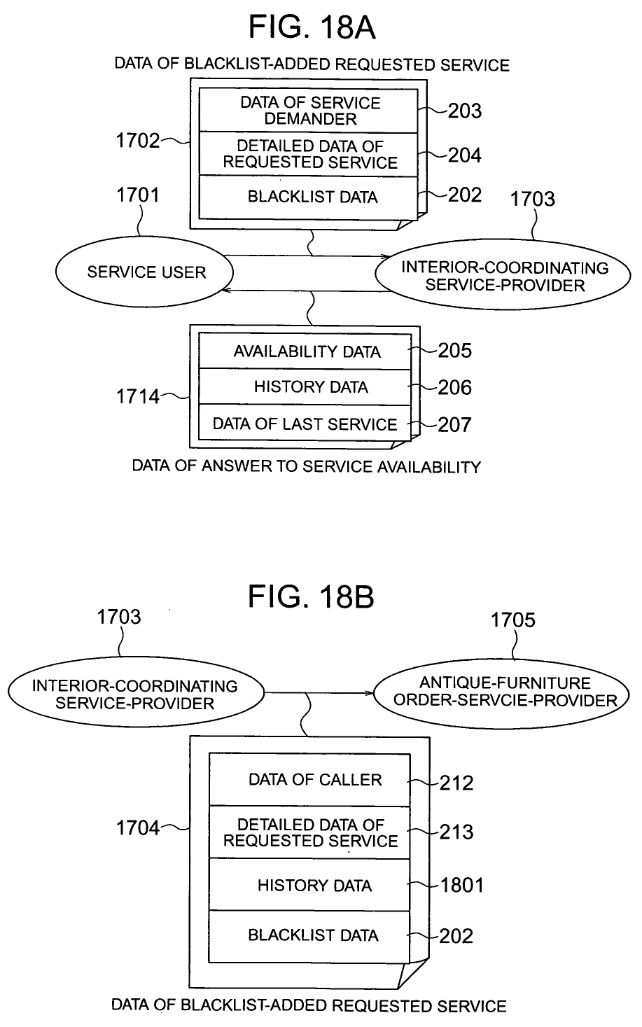

FIGS. 18A and 18B are diagrams for the details of the data transmitted and received so that a service user 1701 calls an interior-coordinating service-provider 1703 and receives an answer and that the provider 1703 calls an antique-furniture order-service-provider 1705 in the embodiment shown in FIG. 17. The blacklist-added requested-service data 1702 shown in FIG. 18A is composed of demander data 203, requested detailed service data 204 and blacklist data 202 shown in FIG. 5.

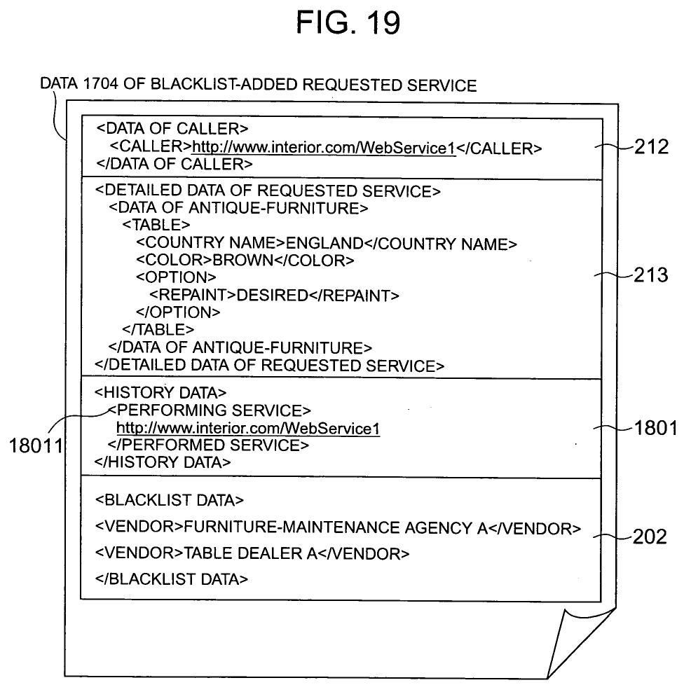

The data of answer to service availability 1714 shown in FIG. 18A is composed of availability data 205, history data 206, and last service data 207 shown in FIG. 6. The blacklist-added requested-service data 1704 shown in FIG. 18B is composed of blacklist data 202 shown in FIG. 5A, caller data 212, data 213 of requested detailed service shown in FIG. 8, and history data 1801 shown in FIG. 19.

FIG. 19 is a diagram of the details of the requested-service data transmitted from the provider 1703 to the provider 1705 in the embodiment shown in FIG. 17.

The history data 1801 shown in FIG. 19 is the data indicative of the history of a called Web service of the multistage-type cooperative Web services. This embodiment specifies a practically performing service 18011 as interior-coordinating service-provider located at http://www.interior.com/WebService1.

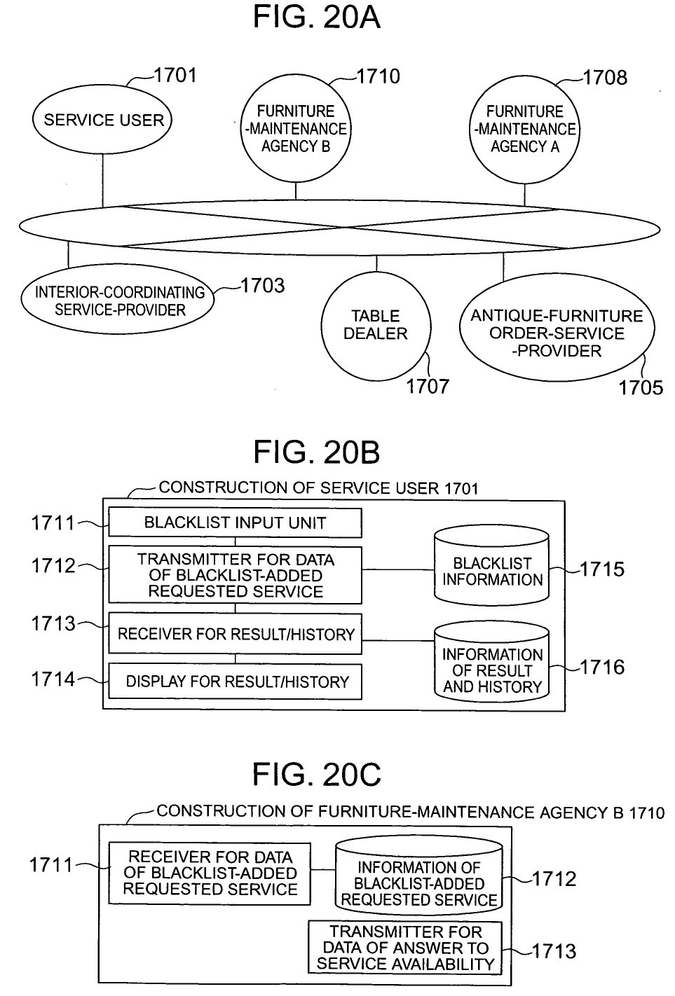

FIG. 20A is a diagram showing the interconnection of service user 1701, furniture-maintenance agency B 1710, and so on shown in FIG. 17.

The service user 1701 shown in FIG. 20B is constructed to have a blacklist input unit 1711 for entering the blacklist, a blacklist information storage 1715 for storing the inputted blacklist information, a transmitter 1712 for transmitting the blacklist-added requested-service data 1702, a result/history receiver 1713 for receiving the result and history, a result/history information storage 1716 for storing the received result and history, and a result/history display 1714 for displaying the received result and history.

The furniture-maintenance agency B 1710 shown in FIG. 20C is constructed to have a receiver 1711 for receiving blacklist-added requested-service data 1709, a storage 1712 for storing the data 1709 of blacklist-added requested service, and a transmitter 1713 for transmitting data 1711 of answer to service availability.

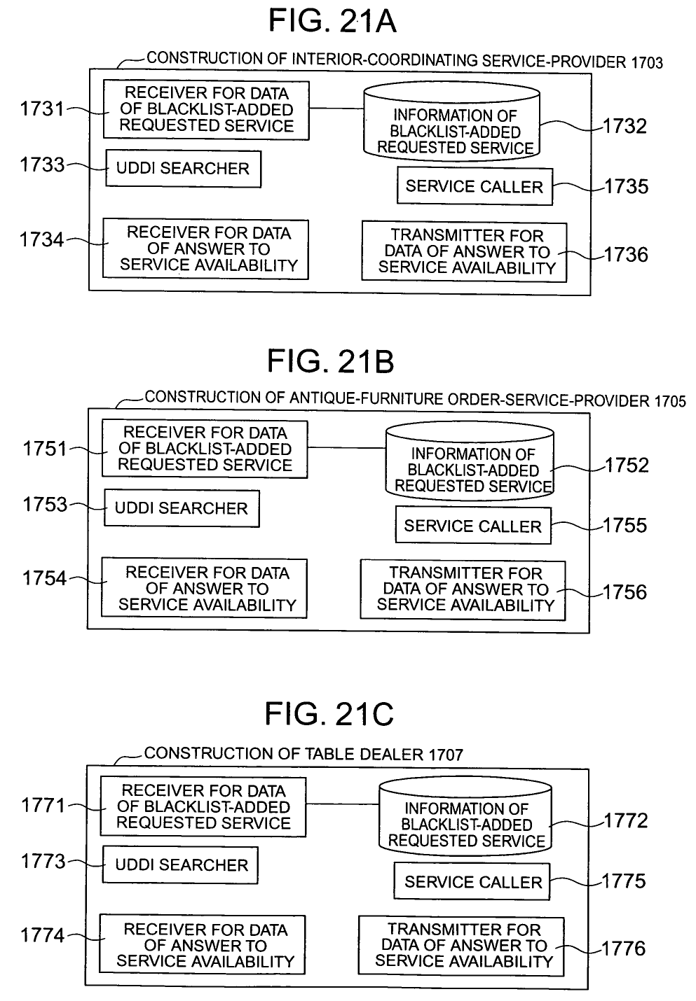

FIGS. 21A through 21C are diagrams showing the constructions of interior-coordinating service-provider 1703, antique-furniture order-service-provider 1705 and table dealer 1707 shown in FIG. 17. The provider 1703 shown in FIG. 21A is constructed to have a receiver 1731 for receiving data 1702 of blacklist-added requested-service, a storage 1732 for storing the received data 1702 of blacklist-added requested service, a UDDI searcher 1733 for searching for a Web service to be called next, a service caller 1735 for calling the next Web service resulting from the search, a receiver 1734 for receiving data 1713 of answer to service availability, and a transmitter 1736 for transmitting data 1714 of answer to service availability.

The provider B 1705 shown in FIG. 21B is constructed to have a receiver 1751 for receiving data 1704 of blacklist-added requested-service, a storage 1752 for storing the received data 1704 of blacklist-added requested service, a UDDI searcher 1753 for searching for a Web service to be called next, a service caller 1755 for calling the next Web service resulting from the search, a receiver 1754 for receiving data 1712 of answer to service availability, and a transmitter 1756 for transmitting data 1713 of answer to service availability.

The table dealer 1707 shown in FIG. 21C is constructed to have a receiver 1771 for receiving data 1706 of blacklist-added requested-service, a storage 1722 for storing the received data 1706 of blacklist-added requested service, a UDDI searcher 1773 for searching for a Web service to be called next, a service caller 1775 for calling the next Web service resulting from the search, a receiver 1774 for receiving the data 1711 of answer to service availability, and a transmitter 1776 for transmitting data 1712 of answer to service availability.

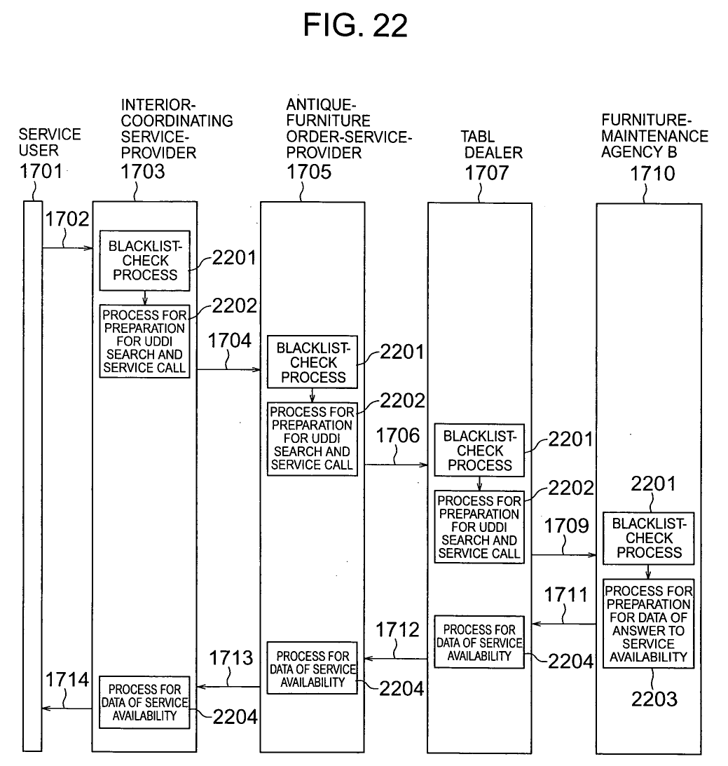

FIG. 22 is a diagram showing the flow of processes for the service user 1701 to inquire as to whether the service user can enjoy a desired service without using the Web services of the companies included in its own blacklist, and to receive the result. The service user 1701 transmits the data of blacklist-added requested-service 1702 to the interior-coordinating service-provider 1703. The provider 1703 makes a check process 2201 (step 2201) on the basis of the received data. Then, it makes a process 2202 for preparation for UDDI search and calls of service (step 2202), and transmits data of blacklist-added requested-requested 1704 to the antique-furniture order-service-provider 1705.

The provider 1705 also makes the check process 2201 (step 2201) on the basis of the received data 1704 as does the provider 1703. Then, it makes the process 2202 for preparation for UDDI search and calls of service (step 2202), and transmits data of blacklist-added requested-service 1706 to the table dealer 1707.

The table dealer 1707 also makes the check process 2201 (step 2201) on the basis of the received data 1706 as do the providers 1703 and 1705. Then, it makes the process 2202 for preparation for UDDI search and calls of service (step 2202), and transmits data of blacklist-added requested-service 1709 to the furniture-maintenance agency B 1710.

The agency B 1710 makes the check process 2201 (step 2201) and process 2203 for preparation for data of answer to service availability (step 2203) on the basis of the received data 1709, and transmits data of answer to service availability 1711 to the table dealer 1707.

The table dealer 1707 makes a process 2204 for data of service availability (step 2204) on the basis of the received data 1711, and transmits data of answer to service availability 1712 to the antique-furniture order-service-provider 1705.

The antique-furniture order-service-provider 1705 makes the process 2204 (step 2204) on the basis of the received data 1712, and transmits data of answer to service availability 1713 to the interior-coordinating service-provider 1703.

The provider 1703 makes the process 2204 (step 2204) on the basis of the received data 1713, and transmits data of answer to service availability 1714 to the service user 1701.

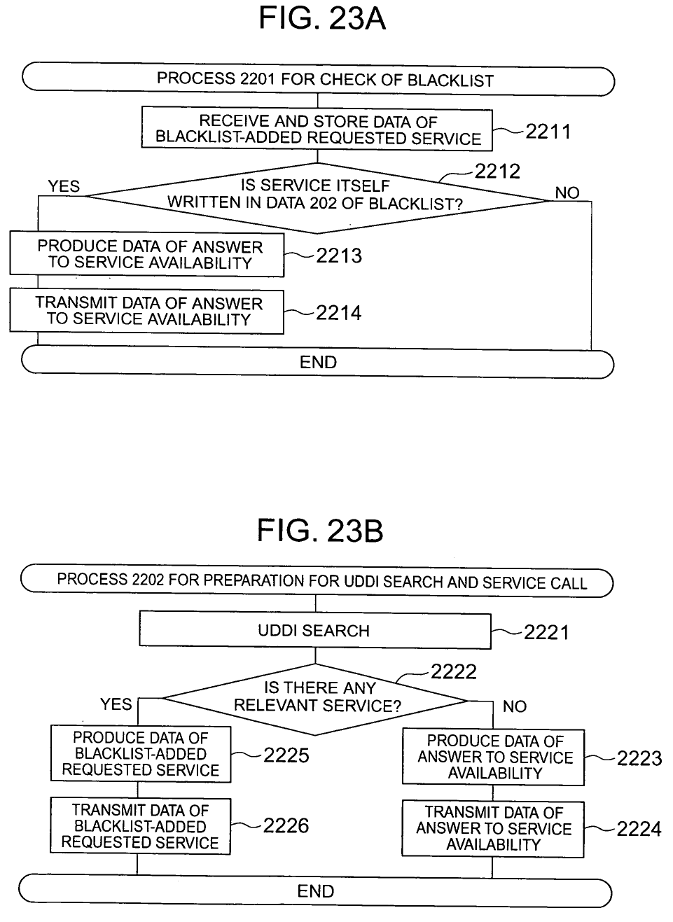

FIGS. 23A and 23B are flowcharts for the details of the processes 2201 and 2202 shown in FIG. 22, respectively. In the process 2201 shown in FIG. 23A, the blacklist-added requested-service data is received and stored (step 2211).

Then, judgment is made of if information of the service itself is included in the blacklist data 202 on the basis of the received blacklist-added requested-service data. If it is included, data of answer to service availability is produced (step 2213), and transmitted (step 2214).

In this case, the availability data 205 of the produced data of answer to service availability is assumed to be NG indicating that the service user cannot enjoy any Web service without using the undesired Web services.

In the process 2202 shown in FIG. 23B, a service desired to call next is searched for by UDDI (step 2221), and judgment is made of if there is any corresponding service as a result of the search (step 2222). If there is not any corresponding service, data of answer to service availability is produced (step 2223), and transmitted (step 2224). If there is a corresponding service, data of blacklist-added requested-service is produced (step 2225), and transmitted to the next Web service (step 2226).

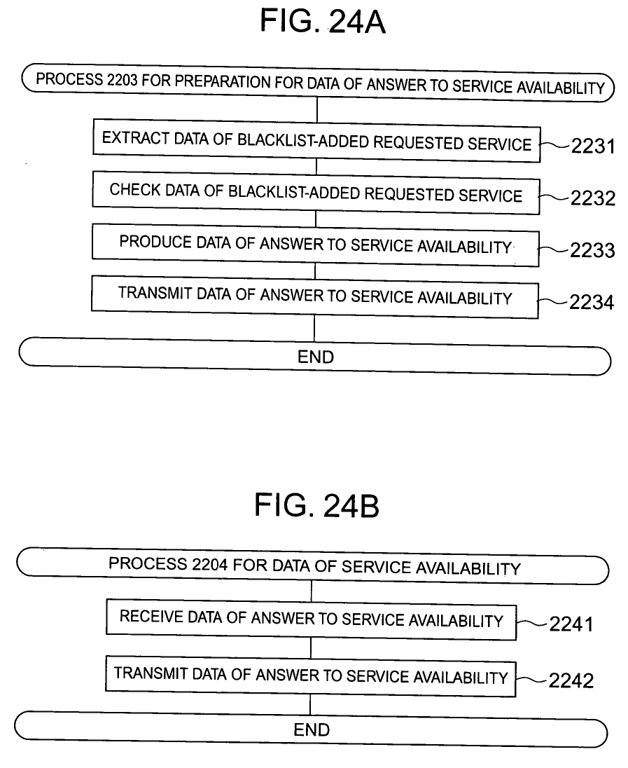

FIGS. 24A and 24B are flowcharts for the details of the processes 2203 and 2204 shown in FIG. 22. In the process 2203 shown in FIG. 24A, data of blacklist-added requested-service is taken out (step 2231), and checked (step 2232). Then, data of answer to service availability is produced (step 2233), and transmitted (step 2234). In this case, the availability data 205 of the produced data of answer to service availability is assumed to be OK indicating that the service user can enjoy a Web service without using the undesired Web services. In the process 2204 shown in FIG. 24B, the data of answer to service availability is received (step 2241), and transmitted as it is (step 2242).

As described above, since the availability information can be previously acquired by using the history data, it is possible to previously check in order that the service user can enjoy a Web service without using the Web services of undesired companies.

In addition, since Web services are not actually launched, it is not necessary to consider the rollback of Web service or the like.

Moreover, since the service user as the client for the prior check can receive not only the availability result but also the history data, the service user can modify its own blacklist according to the priority levels of services based on the history result.

Thus, according to the invention, since the availability information can be previously acquired by using the history data, the service user can check Web services in advance so that the service user can enjoy only the desired services.

Also, since Web services are not actually launched, it is not necessary to allow for the rollback of Web service or the like.

Furthermore, since the service user as the client for the prior check can receive not only the availability result but also the history data, the service user can modify its own blacklist-according to the priority levels of services based on the history result.

It should be further understood by those skilled in the art that although the foregoing description has been made on embodiments of the invention, the invention is not limited thereto and various changes and modifications may be made without departing from the spirit of the invention and the scope of the appended claims.

1. A method of processing services comprising the steps of:
previously transmitting identification information of undesired processing nodes from a first node to a management node so that said identification information of undesired processing nodes can be registered as nodes that said first node does not want to request for processing; and
sending an inquiry from a second node to said management node in accordance with a request for service sent from said first node so that, before said second node requests another node for processing, said second node can check if said other node is one of the nodes that said first node has registered as said undesired nodes, and then transmitting a request for processing from said second node to said other node or still another node that is not registered as a result of said inquiry.

2. A method according to claim 1, wherein said management node is a node that performs UDDI service.

3. A method according to claim 1, wherein before said a node that has received a request for processing transmitted from said first node requests another node for processing, said first-mentioned node inquires said management node as to whether said other node is one of the nodes that said first node previously registered as the undesired nodes in said management node, and then transmits a request for processing to a node that is not registered yet as a result of said inquiry.

4. A method of processing services wherein a node receives a request for service including identification information of nodes that are not desired to request for service processing, and said node, when requesting another node for processing in accordance with said received request, transmits a request for processing to a node other than said undesired nodes included in said received request.

5. A method of processing services comprising the steps of:
previously transmitting necessary information for determining a node to which a service is to be requested for processing from a first node to a management node in order to register said information; and
sending an inquiry from a second node to said management node in accordance with a request for service from said first node so that before said second node requests another node for processing, said second node can check if the node is included in said registered information, and then determining if said request for processing is transmitted to the node in accordance with the result of said inquiry.

6. A system for processing services comprising:
means for previously transmitting identification information of undesired processing nodes from a first node to a management node so that said identification information of undesired processing nodes can be registered as nodes that said first node does not want to request for processing; and
means for sending an inquiry from a second node to said management node in accordance with a request for service sent from said first node, so that, before requesting another node for processing, said second node can check if said other node is one of the nodes that said first node has registered as said undesired nodes, and then transmitting a request for processing from said second node to said other node or still another node that is not registered as a result of said inquiry.

7. A system for processing services comprising:
means for making it possible that a node receives a request for service including identification information of nodes that are not desired to request for service processing; and
means for making it possible that, when said node requests another node for processing in accordance with said received request, said node transmits a request for processing to a node other than said undesired nodes included in said received request.

8. A program for processing services comprising the steps of:
previously transmitting identification information of undesired processing nodes from a first node to a management node so that said identification information of undesired processing nodes can be registered as nodes that said first node does not want to request for processing;
receiving by a second node a request for service from said first node; and
sending an inquiry from a second node to said management node in accordance with said request so that, before requesting another node for processing, said second node can check if said other node is one of the nodes that said first node has registered as said undesired nodes, and then transmitting a request for processing from said second node to said other node or still another node that is not registered as a result of said inquiry.

9. A program for processing services comprising the steps of:
making it possible that a node receives a request for service including identification information of nodes that are not desired to request for service processing; and
making it possible that, when said node requests another node for processing in accordance with said received request, said node transmits a request for processing to a node other than said undesired nodes included in said received request.

10. A method for processing services wherein a node receives a request for service including identification information of nodes that is not desired to request for service processing, and transmits a request for processing to another node in accordance with said received request.

11. A method for processing services, the method comprising the steps of:
transmitting information, from a user node to a management node, on nodes to which the user node does not request a service processing;
registering the nodes in the management in accordance with the information;
sending a request for service processing from the user node to a node in nodes accessible to the user node;
inquiring, in response to the request, from the node to the management node whether or not the node has been registered in the management node; and
performing a service processing at the node in response to an absence of registration of the node in the management node, while sending again the request for service processing to another node which is arranged to perform the same kind of service as that of the node in response to existence of registration of the node in the management node.
